(19) United States
(12) Patent Application Publication
(10) Pub. No.: US 2010/0277933 A1
(43) Pub. Date: Nov. 4, 2010

(54) DOWN LIGHT FIXTURE AND DOWN LIGHT USING THE SAME

(76) Inventor: Chiu-Chia Chen, Taipei (TW)

Correspondence Address: NORTH AMERICA INTELLECTUAL PROPERTY CORPORATION, P.O. BOX 506, MERRIFIELD, VA, 22116, US

(21) Appl. No.: 12/769,660

(22) Filed: Apr. 29, 2010

(30) Foreign Application Priority Data
Apr. 29, 2009 (TW) 098114247

(51) Int. Cl. F21S 8/00

(52) U.S. Cl. 362/432; 362/373

(57) ABSTRACT

A down light fixture and a down light are provided. The down light fixture is used for fixing a lamp holder in a recess housing. The recess housing has at least one fixing portion. The down light fixture includes a bracket and a clip. The bracket is fixed to the lamp holder. The clip is disposed at the bracket, and the clip has a connecting portion and an elastic portion connected with each other. The connecting portion is connected to the bracket, and the elastic portion is contained in the fixing portion. The lamp holder is fixed in the recess housing by disposing the lamp holder in the recess housing and rotating the lamp holder to press the elastic portion into the fixing portion.

### CROSS-REFERENCE TO RELATED APPLICATIONS

This Non-provisional application claims priority under 35 U.S.C. §119(a) on Patent Application No(s). 098114247 filed in Taiwan, Republic of China on Apr. 29, 2009, the entire contents of which are hereby incorporated by reference.

### BACKGROUND OF THE INVENTION

1. Field of the Invention

This invention relates to a fixture and, more particularly, to a down light fixture and a down light using the same.

2. Description of the Related Art

The lamps are widely applied to a plurality of places such as a commercial place or a residential place, and the lamps have become a main illumination system. Further, the lamps have a plurality of different forms. A down light system is one of illumination equipment which is widely used.

The down light system may include two main bodies. One main body is a recess housing generally assembled in a ceiling. When a commerce or residence place is decorated, a hole may be disposed on the ceiling in advance for embedding the recess housing, and power cables such as a commercial power cable may also be connected to the recess housing. The other main body is a down light which is also a main body for generating light. The down light and the recess housing in the ceiling correspond to each other. Therefore, the down light can be assembled in the recess housing, and the power source needed by the down light for illumination is provided via the circuits disposed in the recess housing.

Since the recess housing and the down light in the down light system are separately designed, this design is easy for assembly and replacement when a light-emitting module of the down light is damaged. However, since the separated design is used, the down light system needs a special fixture for firmly fixing the down light to the recess housing. When a user assembles or replaces the down light, the user has to complete the assembly or replacement by operating the fixture.

### BRIEF SUMMARY OF THE INVENTION

This invention provides a down light fixture and a down light using the same. The user may easily combine the down light and a recess housing just by performing a simple rotating operation by an embodiment of the invention.

The embodiment of the invention provides a down light fixture for fixing a lamp holder in a recess housing. The recess housing has at least one fixing portion. The down light fixture includes a bracket and a clip. The bracket is fixed to the lamp holder. The clip is disposed at the bracket, and the clip has a connecting portion and an elastic portion connected with the connecting portion. The connection portion is connected to the bracket, and the elastic portion is contained in the fixing portion. The lamp holder is used to be disposed in the recess housing and rotated to press the elastic portion into the fixing portion for fixing in the recess housing.

The embodiment of the invention also provides a down light suitable for being assembled in a recess housing. The recess housing has at least one fixing portion. The down light includes a lamp holder, a bracket, and a clip. The bracket is fixed to the lamp holder. The clip is disposed at the bracket, and the clip has a connecting portion and an elastic portion connected with the connecting portion. The connecting portion is connected to the bracket, and the elastic portion is contained in the fixing portion. The lamp holder is used to be disposed in the recess housing and rotated to press the elastic portion into the fixing portion.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a bracket according to one embodiment of the invention;

FIG. 2 is a schematic diagram showing a clip according to one embodiment of the invention;

FIG. 3 is a schematic diagram showing a down light fixture according to one embodiment of the invention;

FIG. 4 is a schematic diagram showing a down light according to one embodiment of the invention;

FIG. 5A is a schematic diagram showing a recess housing according to one embodiment of the invention;

FIG. 5B is a first assembled schematic diagram showing a down light and a recess housing according to one embodiment of the invention;

FIG. 5C is a second assembled schematic diagram showing a down light and a recess housing according to one embodiment of the invention; and

FIG. 5D is an assembled schematic diagram showing a down light fixture and a fixing portion according to one embodiment of the invention.

### DETAILED DESCRIPTION OF THE INVENTION

A down light fixture in this invention includes a bracket and a clip. A down light using the same further includes a lamp holder. The bracket and the clip of the fixture are first described, and then the connection relation thereof is described.

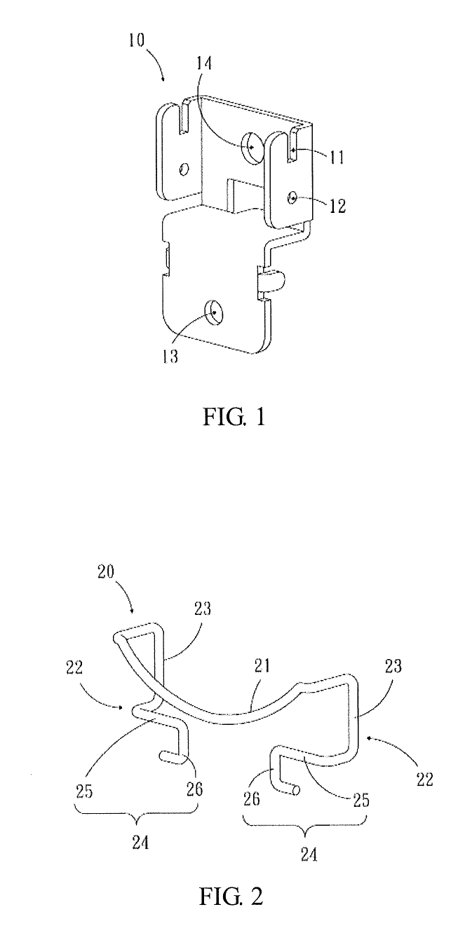

FIG. 1 is a schematic diagram showing a bracket according to one embodiment of the invention. Please refer to FIG. 1. In this embodiment, a bracket 10 includes two grooves 11 corresponding to each other and two openings 12 corresponding to each other. In addition, the bracket 10 can also have two screw holes 13, 14.

FIG. 2 is a schematic diagram showing a clip according to one embodiment of the invention. Please refer to FIG. 2. In this embodiment, a clip 20 has a connecting portion 22 and an elastic portion 21 connected with the connecting portion 22. The connecting portion 22 of the clip 20 includes two supporting arms 23 and two hooked elements 24. The two supporting arms 23 are connected to two ends of the elastic portion 21, respectively. The two hooked elements 24 are connected to the supporting arms 23, respectively, and each of the hooked elements 24 has an upper arm 25 and a lower hook 26.

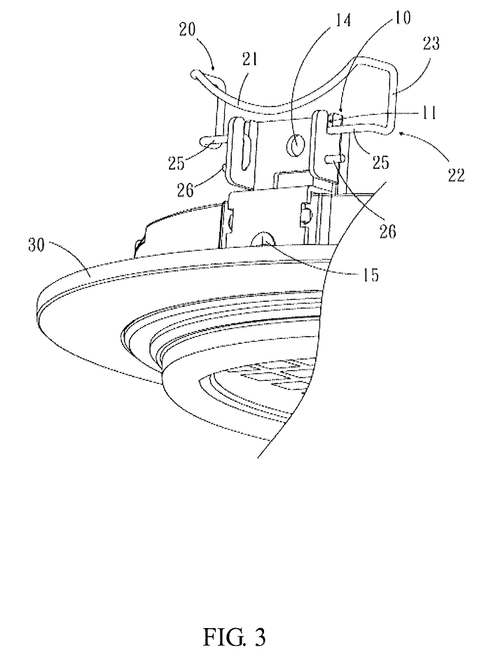

The connection of the bracket 10, the clip 20, and a lamp holder 30 is described hereinbelow. FIG. 3 is a schematic diagram showing a down light fixture according to one embodiment of the invention. In FIG. 3, the clip 20 is disposed at the bracket 10. The connecting portion 22 of the clip 20 is connected to the bracket 10, and the elastic portion 21 and the connecting portion 22 are connected with each other. In this embodiment, the upper arms 25 of the clip 20 are disposed across the grooves 11 of the bracket 10 and the lower hooks 26 of the clip 20 pass through the openings 12, respectively, and thereby connect the clip 20 and the bracket 10.

In FIG. 3, the bracket 10 is connected to the lamp holder 30. In this embodiment, a screw 15 passes through the screw hole 13 to fix the bracket 10 to the lamp holder 30, thereby connecting the bracket 10 and the lamp holder 30.

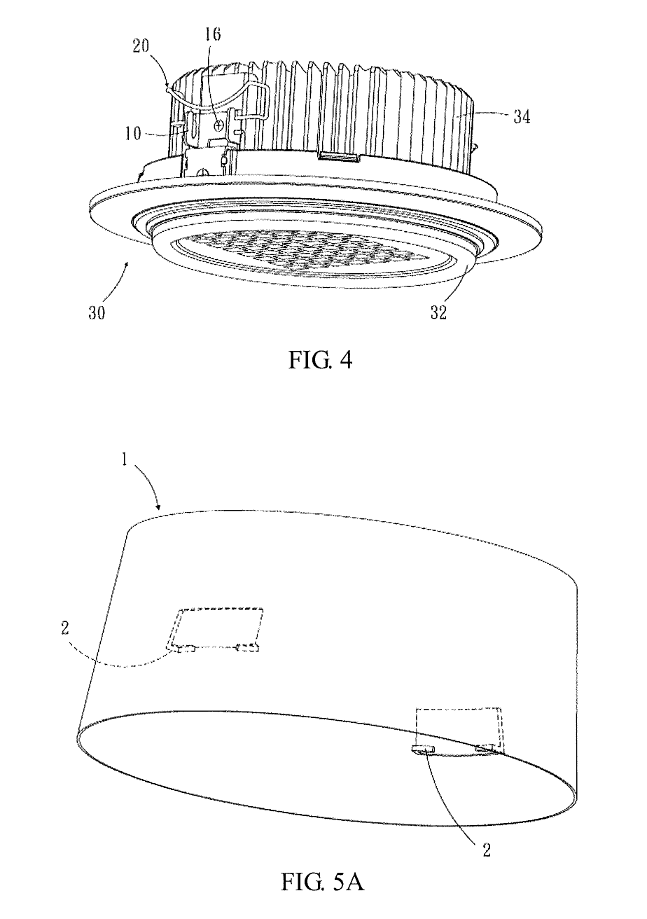

FIG. 4 is a schematic diagram showing a down light according to one embodiment of the invention. The difference between this embodiment and FIG. 3 is that the lamp holder 30 in FIG. 4 includes a light-emitting module 32. In this embodiment, a screw 16 can pass through the screw hole 14 to fix the bracket 10 to the light-emitting module 32. In addition, since one end of the bracket 10 is fixed to the lamp holder 30, the bracket 10 can be firmly fixed to the lamp holder 30 by fixing the other end of the bracket 10 to the light-emitting module 32 of the lamp holder 30.

The light-emitting module 32 may include a light-emitting diode (LED). That is, the LED is used for providing light. Since the LED has a plurality of advantages such as a long lifespan and low power consumption, the down light using the LED also have the above advantages. In addition, the light-emitting module 32 may include a heat-dissipating unit 34, such as a heat-dissipating fin and so on, to prevent the down light from being burned by heat is generated during working. However, the invention is not limited thereto. In FIG. 4, the bracket 10 may be fixed to the heat dissipating unit 34 of the light-emitting module 32.

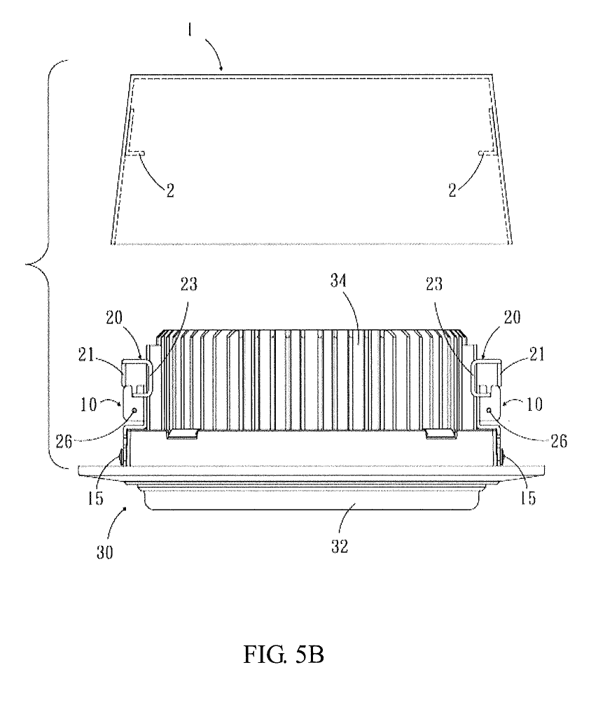

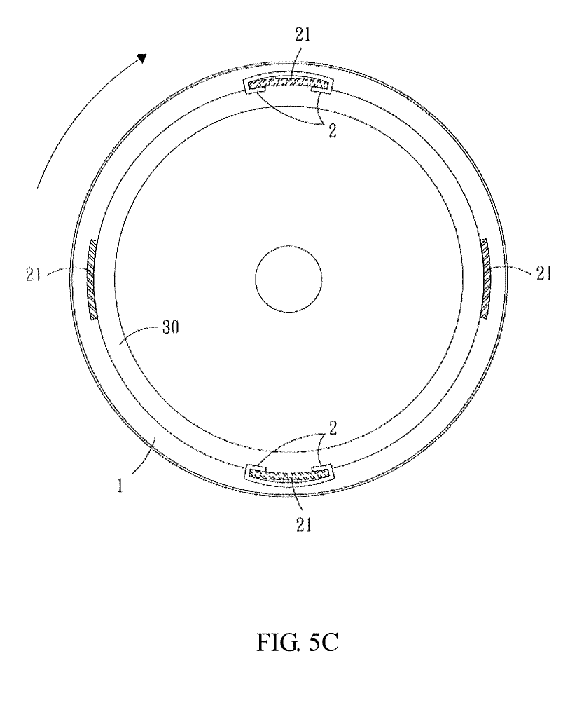

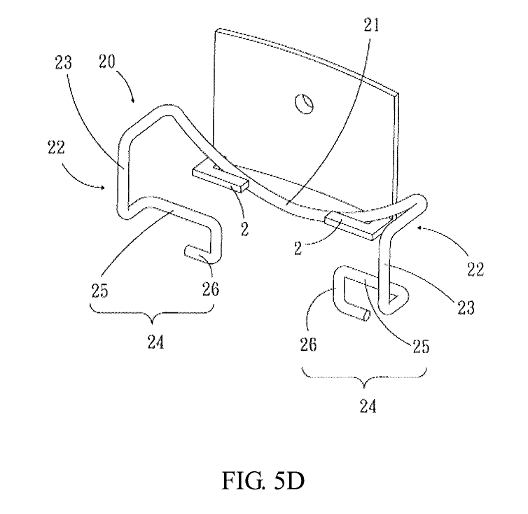

Then, the connection between the down light and the recess housing is described hereinbelow. FIG. 5A is a schematic diagram showing a recess housing. FIG. 5B is a first assembled schematic diagram showing a down light and a recess housing. A recess housing 1 can be assembled in a ceiling. Further, a power cable of commercial power can be connected to the recess housing 1, and a power socket is disposed in the recess housing 1 and connected with the down light for providing power needed by the down light during normal working, the recess housing 1 has a fixing portion 2 to assemble and fix the down light in the recess housing 1.

FIG. 5C is a second assembled schematic diagram showing a down light and a recess housing. How the down light is fixed in the recess housing 1 by the fixture, i.e. the bracket 10 and the clip 20, is described hereinbelow. The fixture of the down light is connected to the lamp holder 30 as mentioned above. At that moment, for assembling the lamp holder 30 in the recess housing 1, the lamp holder 30 is rotated to drive the bracket 10 and the clip 20. When the clip 20 moves to the fixing portion 2 of the recess housing 1, the elastic portion 21 of the clip 20 is pressed to locked into the fixing portion 2, thus to combine the lamp holder 30 and the recess housing 10 and assemble the down light in the recess housing 1.

The detailed connection is shown in FIG. 5D. FIG. 5D is an assembled schematic diagram showing a down light fixture and a fixing portion. FIG. 5D only shows the clip 20 of the down light fixture and the fixing portion 2 of the recess housing 1 to clearly show the connection. According to the above, to fix the lamp holder 30 in the recess housing 1, the lamp holder 30 is used to be disposed in the recess housing 1 and rotated to press the elastic portion 21 of the clip 20 into the fixing portion 2. The elastic portion 21 pressed into the fixing portion 2 is shown in FIG. 5D. In addition, in FIG. 5D, the elastic portion 21 is arc-shaped, and thereby facilitate the elastic portion 21 is pressed into the fixing portion 2.

When the lamp holder 30 of the down light is damaged, the down light has to be separated from the recess housing 1. A user can rotate the elastic portion 21 of the clip 20 out of the fixing portion 2 of the recess housing 1. Thus, the down light will be separated from the recess housing 1 for replacing the lamp holder 30 successfully.

According to the above, the down light can be successfully fixed in the recess housing 1 corresponding to the down light by a rotation mode. Further, the down light and the recess housing 1 can be separated from each other in the same rotation mode for repairing or replacing process.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A down light fixture for fixing a lamp holder in a recess housing, the recess housing having at least one fixing portion, the down light fixture comprising:
at least one bracket fixed to the lamp holder; and
at least one clip disposed at the bracket, the clip having a connecting portion and an elastic portion connected the connecting portion, the connecting portion being connected with the bracket, the elastic portion being contained in the fixing portion, the lamp holder being used to be disposed in the recess housing and rotated to press the elastic portion into the fixing portion for fixing the lamp holder in the recess housing.

2. The down light fixture according to claim 1, wherein the bracket comprises two grooves corresponding to each other and two openings corresponding to each other.

3. The down light fixture according to claim 2, wherein the connecting portion of the clip comprises:
two supporting arms connected to two ends of the elastic portion, respectively; and
two hooked elements connected to the supporting arms, respectively, each of the hooked elements having an upper arm disposed across the groove and a lower hook passing through the opening.

4. The down light fixture according to claim 1, wherein the bracket comprises:
at least one screw hole, one screw passing through the screw hole to fix the bracket to the lamp holder.

5. The down light fixture according to claim 1, wherein the elastic portion is arc-shaped.

6. A down light suitable for being assembled in a recess housing, the recess housing having at least one fixing portion, the down light comprising:
a lamp holder;
at least one bracket fixed to the lamp holder; and
at least one clip disposed at the bracket, the clip having a connecting portion and an elastic portion connected the connecting portion, the connecting portion being connected to the bracket, the elastic portion being contained in the fixing portion, the lamp holder being used to be disposed in the recess housing and rotated the to press the elastic portion into the fixing portion for fixing the lamp holder in the recess housing.

7. The down light according to claim 6, wherein the bracket comprises two grooves corresponding to each other and two openings corresponding to each other.

8. The down light according to claim 7, wherein the connecting portion of the clip comprises:
two supporting arms connected to two ends of the elastic portion, respectively; and
two hooked elements connected to the supporting arms, respectively, each of the hooked elements having an upper arm disposed across the groove and a lower hook passing through the opening.

9. The down light according to claim 6, wherein the bracket comprises:
at least one screw hole, one screw passing through the screw hole to fix the bracket to the lamp holder.

10. The down light according to claim 6, wherein the lamp holder comprises a light-emitting module.

11. The down light according to claim 10, wherein the light-emitting module comprises a light-emitting diode (LED).

12. The down light according to claim 10, wherein the light-emitting module comprises a heat-dissipating unit.

13. The down light according to claim 6, wherein the elastic portion is arc-shaped.
